(19) United States
(12) Patent Application Publication
(10) Pub. No.: US 2008/0243679 A1
(43) Pub. Date: Oct. 2, 2008

(54) Property-related benefit financing method and system

(76) Inventors: John P. McMurray, Woodland Hills, CA (US); Mitchell G. Turley, Calabasas, CA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/729,961

(22) Filed: Mar. 30, 2007

(51) Int. Cl. G06Q 40/00

(52) U.S. Cl. 705/38

(57) ABSTRACT

A method for providing funding for a property-related benefit (PRB) associated with an item of property. A PRB lien is prepared that provides for the funding to obtain one or more specified PRBs related to the property. The PRB lien identifies one or more value and corresponding interest rate associated with each respective PRB obtained. The PRB lien can be the only lien existing against the specified item of property or it can exist in conjunction with one or more other liens against the property. Also, the PRB lien can be canceled at any time without affecting the terms of any other existing liens against the property.

### FIELD OF THE INVENTION

The present invention relates generally to advantageous methods and systems for providing financing to a borrower relative to real property and more particularly to a method and system for providing financing to cover costs associated with benefits related to particular underlying real property.

### BACKGROUND OF THE INVENTION

Generally, when someone purchases real property, such as a home, the borrower borrows money in the form of a mortgage to provide the funds to cover the majority of the purchase price of the property. A mortgage is a lien against the purchased property and is secured by the collateral of the specified property. In return for the loan the borrower is obliged to pay back the amount of the mortgage plus interest within a specified period of time with a predetermined set of payments.

In addition to the purchase price of the property, the purchaser may be faced with various other expenses related to the property, such as various forms of insurance. Private mortgage insurance (PMI) is one form of insurance that may be related to the real property.

Due to the risk that a borrower will default on the loan, lenders typically require protection against the costs associated with such default, costs such as missed interest and principal payments. Protection against default may come in the form of a substantial initial cash outlay by the borrower, which is typically at least 20% of the value of the property. In that case, the lender does not finance more than 80% of the value of the property.

Many borrowers, however, desire to finance more than 80% of the value of the property. One reason for this, as of late, is the skyrocketing values associated with the housing market, which has left fewer people with the ability to put down an initial amount equal to 20% of the property value. Traditionally, lenders who finance more than 80% of the value of a particular property have required a borrower to pay for PMI in order to protect the lender against any default by the borrower. Such insurance is also usually required to sell a mortgage loan to investors if the loan exceeds 80% of the value of the property. PMI covers the shortfall in the value of the property below the amount owed in the event of default and foreclosure.

Because mortgage insurance protects the mortgage holder and not the consumer and, further, because monthly payments for mortgage insurance are not always tax deductible, consumers who cannot deduct PMI expenses are usually very interested in arrangements that allow them to avoid paying for mortgage insurance or, if already paying for PMI, to cease paying for it as soon as circumstances permit. One known arrangement in this regard is a financing arrangement wherein the borrower receives a first mortgage loan for 80% of the value of the property and a contemporaneous second mortgage loan for 10% of the value of the property. The borrower contributes the remaining 10% of the purchase price in cash. The holder of the first mortgage is only financing 80% of the purchase price and, therefore, does not require mortgage insurance. The borrower, on the other hand, only needs to provide 10% of the purchase price of the property and not 20% as would otherwise be the case, that is, because he is borrowing a total of 90% of the value of the property. This type of financing arrangement is referred to as an 80-10-10“piggyback” loan, i.e., with an 80% first mortgage and a 10% piggybacked second mortgage and 10% down payment from the borrower.

Another popular type of piggyback loan is the 80-15-5 loan, where the first mortgage holder lends 80% and a second mortgage for 15% of the property value is also lent to the borrower, who contributes the remaining 5%. This type of “piggyback” arrangement also enables the borrower to avoid paying for PMI because the primary loan is only for 80% of the value of the property. Avoidance of PMI is very appealing to many borrowers. One significant reason is that PMI premiums are not always tax deductible. Alternatively, oftentimes the interest payments on a piggybacked loan are deductible. This additional tax break with respect to the piggyback loan option offsets at least a portion of the additional interest paid by the borrower, i.e., the interest on the 10% second mortgage.

Piggyback loans, however, are not necessarily the best option for many borrowers; particularly borrowers that need to borrow more than 80% of the value of the property, and would otherwise need to pay for PMI. Furthermore, traditional piggyback loans may not even be an available option for certain borrowers. For example, piggyback mortgages are typically available only to borrowers with exceptionally good credit ratings.

Another reason a borrower may opt to obtain PMI, as opposed to taking advantage of a traditional piggyback loan, has to do with the relative stability of the value of the property, particularly with respect to the likely event that the property value increases. For instance, if the value of the property rises sharply within a short period of time, which has been a common recent occurrence, some borrowers will be afforded the opportunity to cancel the PMI policy that much sooner and avoid further premium payments. If the piggyback loan approach had been elected under these circumstances, the borrower would have to continue paying under the less attractive terms of the piggyback loan, even though the value of the property had increased.

The piggyback loan approach may not even be available in certain situations. These situations include the fact that such loans are usually limited to situations where single-family detached homes are purchased and, further, the property must be a primary residence of the borrower. Also, the second, “piggybacked,” loan is often limited to a predetermined amount, e.g., $100,000.

Lastly, with respect to piggyback loans, the interest rate offered on the piggybacked loan is often significantly higher than the rate quoted for the first, or primary mortgage, loan. When overall interest rates fall the borrower must refinance the loan to reduce the overall amount paid, for example, each month in the form of monthly statement payments. That is, even though it may appear financially beneficial, at least in the short term, to avoid PMI by taking advantage of a financing arrangement such as the piggyback loan, in the long term, and even sometimes in the short term, it may be better for certain borrowers to obtain PMI and work towards having it canceled as circumstances permit.

One known method to reduce the burden placed on the borrower when PMI is required is disclosed in U.S. Pat. No. 6,671,677, to May. In the '677 patent, a system and method are described for reducing the mortgage interest rate and mortgage guaranty insurance premium associated with the loan. Discount points that lower the mortgage interest rate are financed into the mortgage loan at the time of loan origination. Further, the PMI premium, which is based heavily on the loan-to-value (LTV) percentage of the loan, is ultimately based, according to the '677 patent, on the original loan-to-value (LTV) percentage, regardless of the amount of discount points financed into the loan. For example, an original loan of $100,000 at 6%, on a property priced at $111,111, results in an original LTV of 90%. If six discount points are purchased and financed into the loan, the resulting LTV is 95.4%, i.e., $106,000/$111,111, which results in a typical LTV rating of 97%. According to the '677 patent, instead of the borrower paying 78 basis points (bps) per year for PMI, a typical amount required in the industry for a 97% LTV rating, the borrower would instead only have to pay 52 bps per year, the amount required for a 90% LTV.

A further system and method for financing PMI is disclosed in U.S. Published Patent Application Number 2005/1018028 to Arehart. In accordance with one embodiment of the '028 application, a mortgage loan is adjusted to include a base amount and an excess amount. The excess amount is equal to an amount required to purchase a prepaid PMI policy insuring the mortgage and the interest rate on the loan is adjusted above the prevailing rate to account for the PMI policy premium. At closing the borrower is offered the option of purchasing discount points to reduce the interest rate, e.g., to the prevailing rate, or accepting the loan at the rate above the prevailing rate and receiving the net cash disbursement at closing including both the base and excess amounts. Thus, in accordance with the '028 application, an excess amount equal to the funds required for PMI are optionally added to the base amount of the loan. However, the interest rate on the entire loan, i.e., the base plus excess amount, is fixed for the life of the loan based on the loan amount.

Another method of financing PMI includes a method where the loan rate is adjusted up from the otherwise “market” rate. Under this scenario the additional funds resulting from the increased rate are used to pay for the PMI policy. In this situation the borrower is stuck paying at the increased rate throughout the life of the loan, regardless of the value of the underlying property.

Another exemplary type of insurance typically obtained by borrowers with respect to real property is homeowners insurance (HOI). Homeowners insurance is insurance that protects against various losses related to one's home, its contents, loss of its use, loss of other personal possessions of the homeowner, as well as liability insurance for accidents that may happen at the home.

The cost of homeowners insurance often depends on what it would cost to replace the house and which additional “riders,” i.e., additional items that are insured, are attached to the policy. The insurance policy itself is a lengthy contract, and names what will and what will not be paid in the case of various events. Typically, claims due to earthquakes, floods, “Acts of God”, or war are excluded.

As already discussed, most home buyers borrow money to purchase a home and this loan is usually in the form of a mortgage. Furthermore, mortgage lenders virtually always require that the buyer purchase homeowners insurance as a condition of the loan, in order to protect the bank if the home is subsequently destroyed before the loan is paid-off.

Another example of insurance a homeowner might consider, either at the time of purchasing a home or at some time later, is home warranty insurance. A home warranty insurance policy is a contract that guarantees the repair or replacement of certain appliances or systems in a home. Accordingly, the names ‘home warranty’ insurance and ‘home repair’ insurance are used interchangeably throughout this specification. Home warranties, also known as residential services contracts, are available for both newly constructed homes as well as existing homes. Many home owners purchase home warranty insurance in order to protect themselves against the cost of future home repairs and to provide themselves with peace of mind. Home warranty insurance covers, among other things, the repair or replacement of items including roofing, wiring, plumbing, heating and cooling systems and major appliances.

Home warranty insurance can be purchased by the buyer of the home in order to protect against future repair and replacement costs.

Each of the exemplary insurance policies discussed above represents a respective arrangement for protecting a certain individual with respect to a certain aspect of the purchase of property. Whether it is the bank lending the money for the purchase of the property being protected against default by the borrower or the purchaser of the property being protected against various circumstances related to the property, each respective policy is somehow tied to the underlying property.

It would be beneficial, therefore, to provide systems and techniques for designing and implementing financing with respect to property in such a way as to provide enhanced value, for example, with respect to private mortgage insurance (PMI), homeowner's insurance, home warranty/repair insurance and other types of expense items that are related to the underlying property.

Heretofore, a borrower/purchaser would seek protection for such things as discussed above, independently. For example, at the time of closing for a mortgage loan, the borrower would have to pay for PMI or otherwise prove that PMI was obtained, as required by the lender. Under another scenario the borrower would accept an increased interest rate in return for the lender paying for PMI directly. Then, at some future time, i.e., when the equity in the property exceeded twenty percent, the borrower would either have to refinance the primary loan or otherwise have the PMI canceled, if permitted to do so. Additionally, the homeowner would have to manage independent homeowner's and warranty insurance policies with independent payment schedules.

A beneficial financing method and system are, therefore, contemplated where the costs associated with property-related benefits, such as the insurance products discussed above, are covered by a cancellable lien that can be canceled without impacting any other lien that may be in place.

### SUMMARY OF THE INVENTION

In view of the aforementioned conventional approaches to financing a loan for real property and obtaining various property-related benefits, exemplary embodiments of the present invention offer beneficial alternatives.

An objective of certain exemplary embodiments of the present invention is to provide a financing method in which a lien is prepared specifically to obtain at least one property-related benefit, either in conjunction with one or more other liens on the property, or otherwise entirely on its own without any other liens on the property being obtained. Further, the at least one property-related benefit covered by the lien can be canceled without affecting the terms of any other lien that may be in place with respect to the property.

In accordance with the above and other objectives, an exemplary embodiment of the present invention includes preparing a property-related benefit (PRB) lien for obtaining at least one benefit associated with at least one specified item of property, wherein the PRB lien includes at least one PRB interest rate determined by the particular respective benefit or benefits for which the PRB lien is prepared.

According to a further exemplary embodiment of the invention a method is provided which includes preparing a primary lien comprising a primary amount and a primary interest rate, wherein the primary amount is to be paid back by the borrower over a specified period of time at the primary interest rate, preparing a property-related benefit (PRB) lien comprising at least one PRB interest rate to be applied to a specified value associated with at least one of the primary lien and a specified item of property and permitting the PRB lien to be canceled during a lifetime of the primary lien without affecting the terms of the primary lien.

An even further exemplary embodiment of the invention includes a financing method including preparing a property-related benefit (PRB) lien, wherein the PRB lien is for obtaining a benefit associated with a specified item of property and assigning at least one PRB interest rate to the PRB lien, wherein the at least one PRB interest rate is or are determined by the particular benefit or benefits for which the PRB lien is prepared.

Another exemplary embodiment of the invention includes a financial product comprising a property-related benefit (PRB) lien for providing funding for a benefit associated with a specified item of property and including at least one PRB interest rate applied to a value related to the item of property.

A further exemplary embodiment of the invention is provided in the form of a financial product comprising a PRB lien having a PRB interest rate and for obtaining a particular benefit associated with an item of property for a customer, wherein the benefit is provided by a second party different than the customer and no funds are transferred to the customer and wherein further, the PRB interest rate is determined by the particular benefit.

A still further exemplary embodiment of the invention is provided in the form of a computer program product for providing a financial product to a borrower related to a specified item of property, the computer program product comprising a computer readable medium, a first set of program instructions for preparing a property-related benefit (PRB) lien for obtaining a benefit associated with at least one specified item of property, wherein the PRB lien includes a PRB interest rate determined by the particular benefit for which the PRB lien is prepared.

A further exemplary embodiment includes a computer program product for providing a financial product to a borrower for the purpose of obtaining at least one benefit related to real property, the computer program product comprising a computer readable medium, a first set of program instructions for preparing a PRB lien for obtaining a benefit associated with the real property, wherein no money is transferred to the borrower and a second set of program instructions for assigning an interest rate to the PRB lien, wherein the interest rate is determined by the particular benefit obtained.

A yet further exemplary embodiment of the invention is in the form of a system comprising a user interface for receiving at least one parameter of a financial product, a computer for executing, based on the parameters received via the user interface, instructions comprising a first set of program instructions for preparing a PRB lien for obtaining a benefit associated with real property, wherein no money is transferred to the borrower, a second set of program instructions for assigning an interest rate to the PRB lien, wherein the interest rate is determined by the particular benefit obtained, and an output for displaying results of the execution of the instructions.

### BRIEF DESCRIPTION OF THE DRAWINGS

The object and features of the present invention will become more readily apparent from the following detailed description of the preferred embodiments taken in conjunction with the accompanying drawings in which:

FIG. 1A is a graphical representation of a general exemplary embodiment of a financing method in accordance with the present invention.

FIG. 1B is a graphical representation of a more specific financing method in accordance with an exemplary embodiment of the present invention.

FIG. 1C is a graphical representation of a more detailed financing method in accordance with the exemplary embodiment of the present invention shown in FIG. 1B.

FIG. 1D is a graphical representation of a financing method in accordance with a stand-alone exemplary embodiment of the present invention where no additional liens other than a PRB lien are secured.

FIGS. 2A and 2B illustrate exemplary statements for a lien in accordance with an exemplary embodiment of the present invention.

FIG. 3 illustrates an exemplary statement indicating various amounts due including amounts associated with a PRB lien in accordance with an exemplary embodiment of the present invention.

FIG. 4A illustrates a further exemplary statement indicating various amounts due including amounts associated with a primary lien, a home equity line of credit (HELOC) and a PRB lien in accordance with an exemplary embodiment of the present invention.

FIG. 4B illustrates a further exemplary statement indicating various amounts due including amounts associated with a HELOC and a PRB lien in accordance with an exemplary embodiment of the present invention.

FIG. 5 illustrates a further exemplary statement indicating various amounts due including amounts associated with a stand alone PRB lien in accordance with an exemplary embodiment of the present invention.

FIG. 6 illustrates a further exemplary embodiment in accordance with the present invention in the form of a computer program product.

### DETAILED DESCRIPTION OF EXEMPLARY EMBODIMENTS

Exemplary embodiments of the present invention are discussed in detail below. While specific methods and values are discussed, it should be understood that this is done for illustration purposes only. A person skilled in the relevant art will recognize that other specific methods and values may be used without departing from the spirit and scope of the invention.

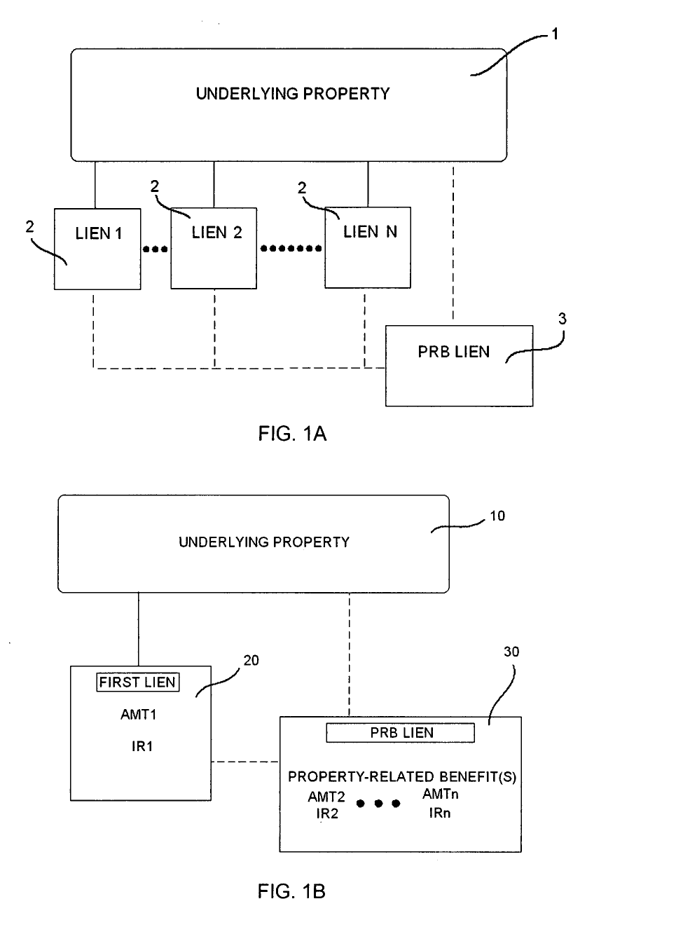

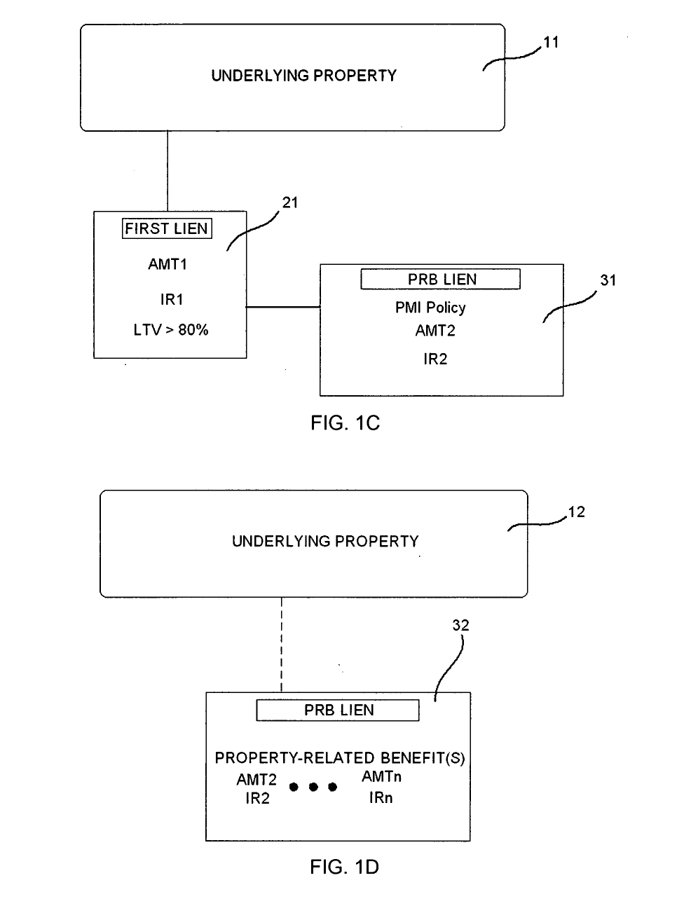

According to a general embodiment of the invention, illustrated in FIG. 1A, a property-related benefit (PRB) lien 3 is prepared in accordance with the present invention. PRB lien 3, as described in detail below in connection with various exemplary embodiments, represents a lien against property 1 and is established specifically to fund a benefit, or number of benefits, related to the underlying property. Also, in accordance with the financing method of the invention, zero, one or more additional liens 2 are prepared with respect to the item of underlying property 1. For example, as shown in FIG. 1A, the additional liens 2, i.e., “LIEN 1” through “LIEN N,” are prepared in connection with underlying property 1. As will be described in more detail below, each additional lien 2 represents a separate lien against the underlying property 1 and each of these liens can be prepared by the same lender, different lenders or any combination of lenders. Further, it is important to note that according to the invention, the PRB lien in accordance with the invention can stand alone, that is without any other additional liens 2, or it can exist along with any number of additional liens 2. As also described below, and as represented in FIG. 1A by the dashed lines connecting the PRB lien 3 to the underlying property 1 and each additional lien 2, the terms of PRB lien 3 can be based on one or more parameters associated with underlying property 1 and/or parameters associated with any number of additional liens 2.

Consistent with the general embodiment of the invention illustrated in FIG. 1A, according to an exemplary embodiment of the invention, illustrated in FIG. 1B, a borrower borrows money from a lender to purchase the underlying property, for example, real property 10, such as a home. According to this exemplary embodiment, a first lien 20 is prepared. The first lien 20 comprises an amount, AMT1, equal to a certain percentage of the value of the underlying property 10 for which the loan is being obtained. Additionally, the first lien 20 comprises a first interest rate, IR1, which is applied to the amount AMT1 to determine the value of periodic payments the borrower will have to make pursuant to first lien 20.

According to the embodiment of FIG. 1B, in addition to first lien 20, a property-related benefit (PRB) lien 30 is also prepared by the lender. It is noted, however, that in accordance with the present invention, the PRB lien can be established by the same lender as the one that established first lien 20, or it can be established by an entirely different lender or other party. Further, PRB lien 30 does not provide for transfer of any fixed amount of money directly to the borrower with respect thereto. PRB lien 30 has an ancillary interest rate that is associated with at least one aspect of the underlying property 10 and/or possibly first lien 20. More particularly, as represented by the dashed lines connecting PRB lien 30 to both the underlying property 10 and first lien 20 in FIG. 1B, the repayment value associated with PRB lien 30 is determined, at least partially, by at least one aspect of either the underlying property (e.g., the value of the property), or the first lien (e.g., the outstanding balance due) or both. The possible relationships between a PRB lien in accordance with the present invention and other, additional liens, is described in further detail below.

As will become clear from the further exemplary embodiments discussed below, a PRB lien in accordance with the instant invention is a stand-alone financing feature that can be associated with other financing tools, such as the first lien 20 in the exemplary embodiment shown in FIG. 1B, a home equity line of credit (HELOC), additional subordinate mortgage liens and other available financing tools, or the PRB lien can stand alone, as illustrated in FIG. 1D, where no other financing tools are in play, for example, when a property owner owns the underlying property outright and seeks to take advantage of the PRB lien merely to fund a certain property-related benefit (PRB) or a number of such benefits. AMT2 through AMTn in FIG. 1B represent the respective amounts associated with a number of various PRBs and IR2 through IRn represent the corresponding interest rates associated with each of the one or more PRBs.

According to a further exemplary embodiment, consistent with the embodiment illustrated in FIG. 1B, the ancillary rate, e.g., IR2, is applied to a percentage of the value of the underlying property 10 at a specified time. In accordance with an alternate exemplary embodiment, the ancillary rate is applied to a percentage of the balance due on the first lien 20 at some specified time, such as the balance at origination or the amortizing balance at some point during the life of the loan. In any event, the ancillary interest rate determines an additional amount owed by the borrower based on parameters attendant to either the first lien 20 or the underlying property 10. According to this exemplary embodiment, at some point in time after the loan attendant to first lien 20 and PRB lien 30 are originated, PRB lien 30 can be canceled without affecting any other aspects of the property or any other liens associated therewith, such as the loan terms associated with first lien 20.

As illustrated in FIG. 1B, an ancillary interest rate, e.g., IR2 through IRn, is associated with each component of the PRB lien. In this embodiment, each ancillary rate is associated with one or more respective aspects of either the first lien and/or the underlying property. More particularly, the interest rate, or rates, corresponding to the PRB lien is, or are, determined based on the underlying purpose(s), i.e., benefits, of the PRB lien. For example, the PRB lien can be used to obtain one or more insurance policies, such as those mentioned above or any other property-related benefit.

According to one or more exemplary embodiments of the invention, the PRB lien comprises respective ancillary interest rates associated with one or more insurance policies. The premiums for each of the insurance policies are determined based at least partially on a respective value associated with the underlying property or a value associated with the first lien. For example, to determine the actual amount due with respect to each of the obtained property-related insurance policies, the respective ancillary interest rate for each insurance policy obtained may be applied to the original loan amount of the first loan, the value of the underlying property at any given time, the current amount owed on the first lien or any other value associated with the first lien, the underlying property, or both.

FIG. 1C illustrates a further, more specific, example of the embodiment illustrated in FIG. 1B. In particular, in FIG. 1B, with respect to first lien 21 the borrower borrows a first amount (AMT1) that is greater than 80% of the appraised value of the property and, thus, the lender requires private mortgage insurance (PMI), as discussed above.

As shown in FIG. 1C, a lender (not shown) prepares first lien 21 including a first amount, AMT1, which is greater than 80% of the appraised value of the underlying property 11 being purchased, i.e., with a loan-to-value (LTV) that is greater than 80%. Further, a first interest rate, IR1, is also associated with first lien 21. Additionally, the lender also prepares a PRB lien, 31 on the underlying property. According to this exemplary embodiment, PRB lien 31 comprises a PMI premium payment based on the amount borrowed with respect to the loan associated with first lien 21. As discussed above, the PMI policy is required by the lender because the amount of the first, or primary, lien is greater than 80% of the appraised value of the underlying property 11 for which the loan is being obtained. In this example, the PRB lien is associated with an aspect of first lien 21, i.e., the borrowed amount, therefore a solid line connects PRB lien 31 to first lien 21 in FIG. 1C. Furthermore, because in this exemplary embodiment the calculation of the amount due under PRB lien 31 is not directly tied to an aspect of the underlying property, i.e., other than through the first lien 21, no line connects PRB lien 31 to the underlying property 11 in FIG. 1C. However, PRB lien 31 remains a lien on the underlying property 11.

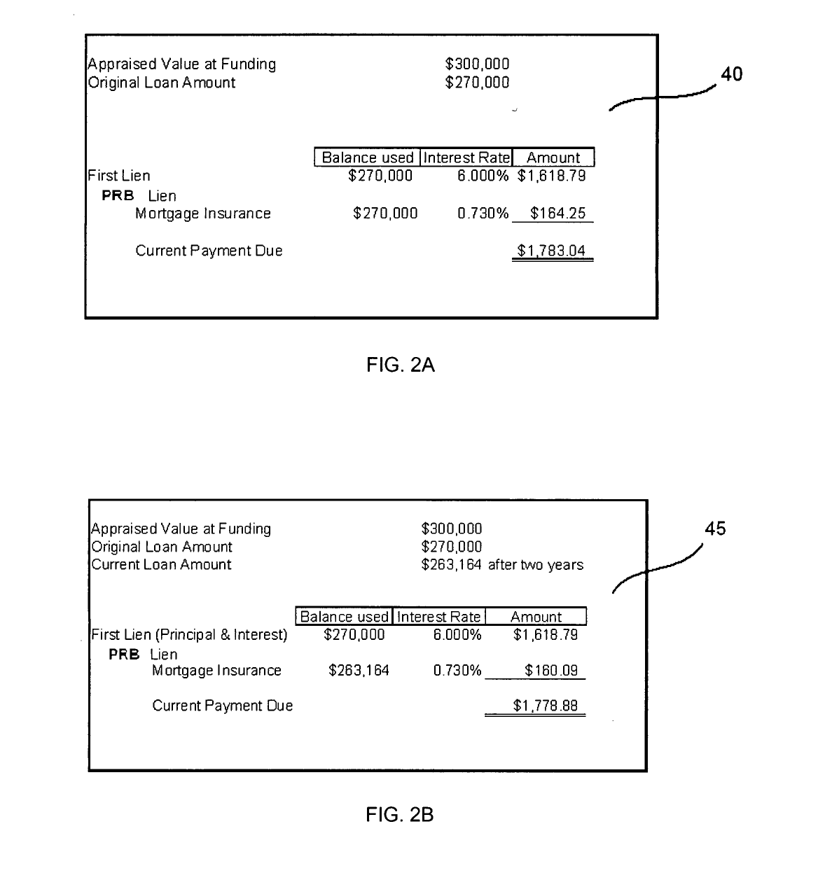

FIGS. 2A and 2B illustrate further detailed examples of the financing method shown in FIGS. 1A through 1C, using exemplary values. Specifically, FIG. 2A illustrates a conceptual monthly statement 40 that would be provided to a borrower upon closing a loan in accordance with an exemplary embodiment of the invention, and FIG. 2B illustrates a monthly statement 45 that would be provided to the same borrower as in FIG. 2A, but at a time two years after closing of the loan. As discussed in detail below, the exemplary loan illustrated in FIGS. 2A and 2B includes a first lien and a PRB lien in accordance with the present invention.

As shown in FIG. 2A, the appraised value of the property at the time of funding is $300,000. Further, the borrower borrows $270,000 (AMT1 from FIGS. 1B and 1C) at an interest rate of 6.00% (IR1 from FIGS. 1B and 1C) to fund the purchase of the property. Accordingly, the loan-to-value (LTV) of the subject loan is 90%, i.e., $270,000/$300,000. Because the LTV is greater than 80%, the lender requires PMI to protect itself against losses in the event the borrower defaults on the loan. A typical PMI policy for an LTV of 90% requires an annual payment of 73 basis points (bps); one basis point being equal to 1/100^{th} of one percent. Therefore, as shown in FIG. 2A, the interest rate for the mortgage insurance is 0.73%. Accordingly, as shown in FIG. 2A, at the time of funding, i.e., at closing, the borrower is required to pay a monthly principal and interest (PI) payment of $1,618.79, which is calculated in accordance with equation 1, below, as well as a monthly PMI premium equal to $164.25, which is calculated in accordance with equation 2, below.

$$\begin{matrix}\begin{matrix}Monthly PI payment = [ ( {AMT}_{1} ) ( {IR}_{1} / 12 ) ] / [ 1 - ( 1 + IR 1 ) \hat{} n ] \\ = ( \$270 , 000 ) ( .06 / 12 ) ] / [ 1 - ( 1 + .06 ) \hat{} 360 ] \\ = \$1618 .79\end{matrix} & ( Eqn . 1 ) \\ \begin{matrix}PMI monthly premium = ( {AMT}_{1} ) ( 1 / 100 ) ( IR 2 / 12 ) \\ = ( \$270 , 000 ) ( 1 / 100 ) ( 0.73 / 12 ) \\ = \$164 .25\end{matrix} & ( Eqn . 2 )\end{matrix}$$

According to equations 1 and 2, where IR2 is the interest rate applied to the PRB lien at the beginning of the loan period, i.e., immediately following closing of the loan, the borrower owes a total of $1,783.04, the sum of the monthly PI and PMI premium payments. Typically, PMI premiums remain fixed throughout the life of the policy, that is, until PMI is canceled or otherwise no longer required. However, as discussed below, in accordance with the present invention, PMI premiums can change during the life of the policy.

FIG. 2B illustrates a further aspect of the financing method in accordance with an exemplary embodiment of the present invention. In particular, according to this embodiment, the monthly PMI premium payment is calculated based on the current loan balance due. For example, as shown in FIG. 2B, after 2 years, i.e., 24 months, of monthly payments, the loan balance is equal to the original loan amount, i.e., $270,000, minus the total principal amount paid up to that point. Specifically, after 24 months the remaining principal owed is approximately $263,164. According to this embodiment, because the PMI premium payment is based on the current loan amount, the PMI premium is determined according to equation 3 as follows.

$$\begin{matrix}PMI monthly premium = ( Current Loan Amount ) ( 1 / 100 ) ( IR 2 / 12 ) \\ = ( \$263 , 164 ) ( 1 / 100 ) ( 0.73 / 12 ) \\ = \$160 .09\end{matrix} \qquad ( Eqn . 3 )$$

In equation 3, above, the interest rate applied for the PRB lien i.e., IR2, remains at 73 basis points because it is typical in the industry to maintain the PMI interest rate fixed until the PMI is no longer required. However, it is contemplated that the rate applied for the PRB lien could change periodically, for example each month, based on predetermined factors, such as the changing value of the property.

More particularly, if the value of the property had risen sharply over the two year timeframe contemplated with respect to the embodiment of FIG. 2B, the interest rate for the PMI could, if desired, be reduced as a result of the lower LTV. For example, if the value of the property rose from $300,000 to $320,000 over the two year period, the LTV at this point would be 82.2%, i.e., $263,164/$320,000. Under these conditions, according to a further exemplary embodiment, the interest rate for the PMI policy would be less than 73 basis points. For example, with an LTV of 82.2% the lender may only require 30 basis points for the PMI coverage. According to this exemplary situation, the new PMI premium, i.e., in the 25^{th} month, would be calculated according to equation 4.

$$\begin{matrix}PMI monthly premium = ( Current Loan Amount ) ( 1 / 100 ) ( IR 2 / 12 ) \\ = ( \$263 , 164 ) ( 1 / 100 ) ( 0.30 / 12 ) \\ = \$65 .79\end{matrix} \qquad ( Eqn . 4 )$$

In any event, according to exemplary embodiments of the financing method of the present invention, the interest rate applied for the PRB lien can be eliminated at any time after its initiation without affecting the terms of any other lien also associated with the property. For example, with respect to the embodiment illustrated in FIGS. 2A and 2B, if and when the LTV of the first lien drops below 80% and PMI is no longer required, the PRB lien can be eliminated and the borrower would thereafter only be required to service the first lien. This is quite a different situation than would be the case for a conventional lien where the borrower would have to refinance the loan in order to eliminate the PMI, such as would be the case if the borrower did not have a PRB lien in accordance with the invention and, instead, accepted the terms of a higher interest rate on the first lien in order to have the lender purchase the PMI.

In accordance with a further aspect of the invention, the interest rate for the PRB lien can remain fixed throughout the life of the property-related benefit to which it is attached, or it may change depending on the applicable parameters used, such as LTV, as discussed above. For example, with respect to the exemplary embodiments discussed above, in which PMI is the property-related benefit supported by the PRB lien, until such time when PMI is no longer required, e.g., when the LTV is less than 80%, the ancillary interest rate, IR2, can be fixed, e.g., at 73 basis points, as opposed to changing during the life of the loan depending on the current LTV.

One feature that remains consistent among the various embodiments of the present invention is that the interest rate applied to each respective property-related benefit (PRB) can be eliminated, thus eliminating the associated payment due, without affecting the terms of other liens, such as the first lien in the previously discussed examples. When the PRB lien is eliminated, the monthly amount owed by the borrower then becomes only that amount determined by the other liens, e.g., the outstanding principal owed and the primary interest rate, IR1, in the examples above.

According to further exemplary embodiments of the present invention, additional insurance policies are added to the PRB lien discussed above. For example, a home owner's policy and/or a home warranty/repair policy can also be included in the PRB lien, with or without the PMI policy.

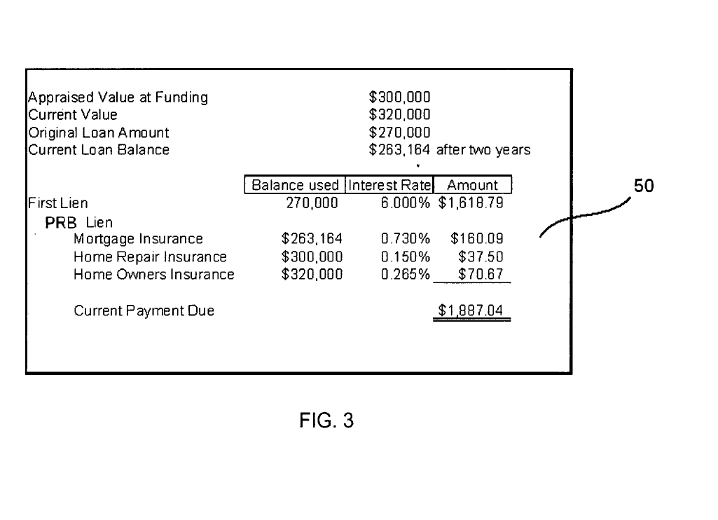

The exemplary embodiment of FIG. 3 includes a home warranty/repair insurance policy and a home owner's insurance policy that are included in the PRB lien along with a PMI policy. Specifically, according to this embodiment, a first lien has been obtained for $270,000 (AMT1) at 6.000% (IR1). Because the amount of the first lien represents an LTV of 90%, PMI is required by the lender. Accordingly, a PRB lien including the PMI policy premium has also been obtained by the borrower in accordance with the invention.

That portion of the PRB lien corresponding to the PMI policy is identical to that which is disclosed above with respect to FIGS. 2A and 2B. Specifically, the premium for the PMI policy is determined based on the current loan balance at the time the payment is being made by the borrower. In this exemplary embodiment, two years have passed since the origination of the loan and, thus, the current loan balance is $263,164, which results in a monthly payment of $160.09, assuming the PMI policy is subject to 73 basis points.

Additionally, the borrower in this exemplary embodiment has agreed to pay the lender for lender-obtained home warranty/repair insurance and home owner's insurance. Regarding the home warranty/repair insurance policy agreed to by the borrower, the balance used to determine the current monthly amount owed is determined by the value of the property at the time of funding. In this embodiment that amount is $300,000. Further, the interest rate corresponding to the home warranty/repair insurance policy in this example is 15 basis points, or 0.150%. Therefore, the additional monthly amount owed to cover the home warranty/repair insurance policy is $37.50.

Lastly, with respect to the home owner's insurance policy, the monthly amount owed is determined based on the current value of the property. In this example, the value of the property has increased from $300,000 to $320,000 over the two year period since the origination of the loan. Accordingly, assuming 26.5 basis points, or 0.265%, is the rate required for the home owner's policy, the additional monthly amount owed to cover the home owner's insurance policy is $70.67.

Therefore, for the exemplary embodiment illustrated in FIG. 3, the borrower owes a total amount of $1,887.04 to cover the first lien as well as the associated PRB lien, which includes a PMI policy, a home warranty/repair insurance policy and a home owner's insurance policy.

As discussed above with respect to the other exemplary embodiments, if and when any or all of the insurance policies are no longer needed or the borrower otherwise wishes to eliminate them, one or more of these insurance policies can be eliminated without affecting the terms of the first lien or any of the remaining elements of the PRB lien. For example, with respect to the exemplary embodiment discussed with respect to FIG. 3, the borrower has the ability to cancel any or all of the PMI, home warranty/repair and home owner's insurance policies virtually at any time during the life of the first lien. Of course, it is possible that certain requirements might have to be met before the specified policy or policies can be cancelled, such as obtaining an LTV less than 80% in the case of PMI, but in any event the ability of eliminating the additional interest rates corresponding to the eliminated property-related benefit remains.

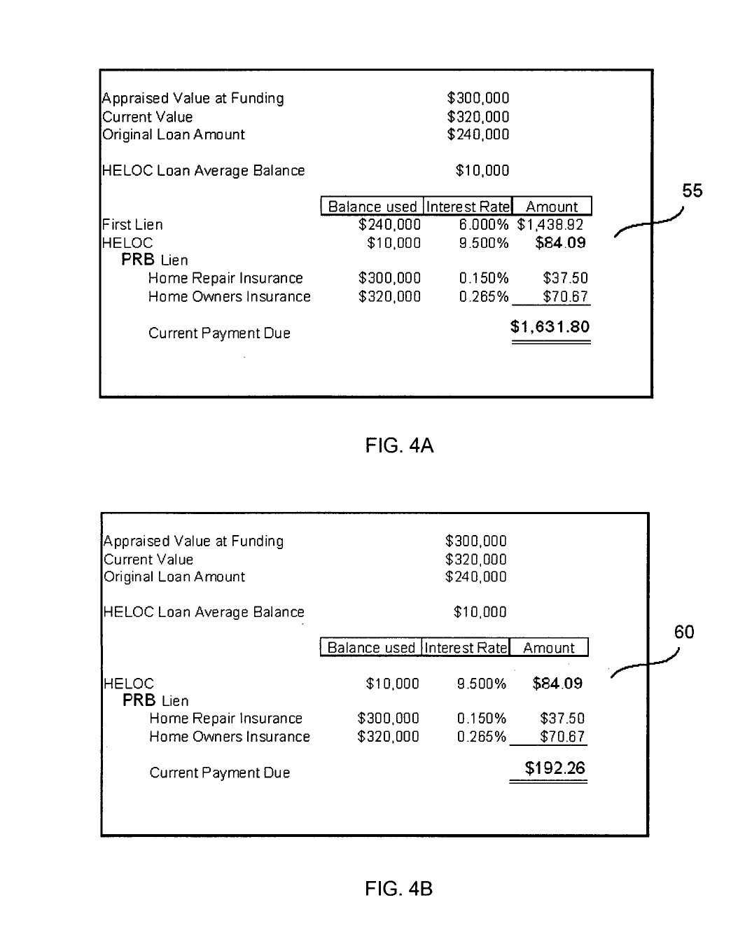

According to a further exemplary embodiment of the invention, a PRB lien is combined with other, optional, financing strategies. For example, according to the exemplary embodiment shown in FIG. 4A, a first lien, an optional home equity line of credit (HELOC) and a PRB lien in accordance with the invention are all obtained in connection with the same real property. Specifically, a first, 30-year, loan of $240,000 at an interest rate of 6.000% is obtained to finance the purchase of a home. This results in a monthly payment of $1,556.43. Further, because the value of the underlying property is $300,000, resulting in a LTV not greater than 80%, i.e., $240,000/$300,000, PMI is not required by the lender for the first lien.

However, in accordance with the embodiment illustrated in FIG. 4A, the borrower wishes to borrow additional funds over and above the $240,000 from the first lien. One option for doing this is for the borrower to establish a home equity line of credit (HELOC), which is another type of lien, using the equity in the property, e.g., an amount comprising the difference between the current value of the home and the current amount owed on the first lien. In the example shown in FIG. 4A, the borrower has borrowed an additional $10,000 using the HELOC. Because the HELOC is subordinate to the first lien it typically demands a higher interest rate than that which is required for the first lien. In this example the interest rate on the HELOC is 9.5%, resulting in an additional monthly payment of $84.09, based on a 30 year repayment schedule; however, one of skill in the art will recognize that other payment schedules can be employed without departing from the spirit of the invention.

In addition to obtaining a first lien and a HELOC, the borrower in this example also obtained a PRB lien in accordance with an exemplary implementation of the present invention. The PRB lien in this example comprises a home warranty/repair insurance policy and a home owner's insurance policy. The home warranty/repair insurance policy required a rate of 15 basis points and the home owner's policy required 26.5 basis points. For the home warranty/repair insurance, the balance used to determine the amount owed is the appraised value at the time the first loan was closed, that is, $300,000, resulting in an additional monthly payment of $37.50. Additionally, the monthly payment for the home owner's policy is based on the current value of the home, which is $320,000 in this example. Accordingly, the home owner's insurance policy requires an additional monthly payment of $70.67.

According to a further exemplary embodiment of the present invention, only a PRB lien and a HELOC lien are obtained and no purchase money lien, such as the “first lien” associated with the exemplary embodiments above, was obtained. FIG. 4B illustrates this exemplary embodiment. As shown, in the embodiment of FIG. 4B all the values are the same as those provided for the embodiment of FIG. 4A. A skilled artisan would know, however, that other values can also be used in accordance with the embodiment of FIG. 4B without departing from the intended scope of the invention. Further, as mentioned above, as is the case for all embodiments described herein, the PRB lien can be funded by the same, or a different, lender than that which funded any one or more of the other liens, such as the first lien, and/or the HELOC included in various embodiments above.

As described with respect to other embodiments of the present invention, with respect to the embodiments illustrated in FIGS. 4A and 4B, one or both of the components of the PRB lien can be eliminated without impacting the first lien (FIG. 4A) or the HELOC lien (FIGS. 4A and 4B). More particularly, if the borrower decides to cancel either the home warranty/repair insurance policy or the home owner's policy at any time, this can be done immediately without affecting the first, purchase money, lien or the HELOC lien, which would remain in force and effect until they are satisfied.

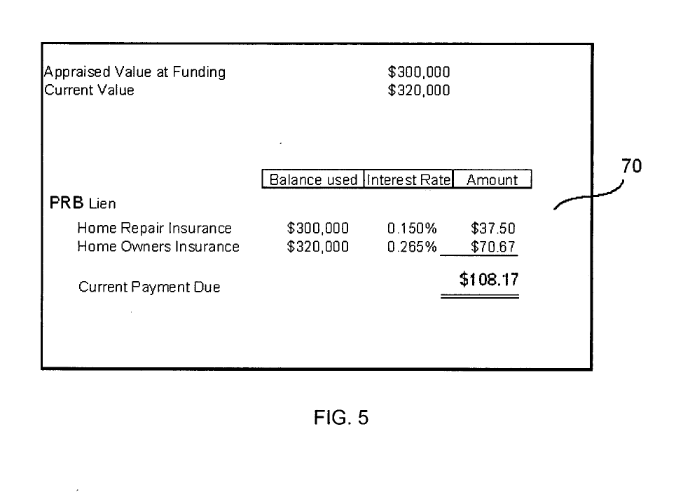

Another exemplary embodiment of the present invention is illustrated in FIG. 5. In regard to the exemplary statement shown in FIG. 5 a PRB lien alone is obtained by a borrower as illustrated, for example, in the embodiment shown in FIG. 1D. That is, in this embodiment, there are no other liens against the underlying property other than the PRB lien. For example, as shown in FIG. 1D, a property owner who owns his or her property outright, i.e., with no mortgage(s), no lines of credit and no other debt or other form of lien against the property 12, may wish to obtain a PRB lien 32 in accordance with the present invention to pay for any of the insurance products previously mentioned above and/or for any other property-related reason.

As illustrated in the embodiments above, the present invention comprises a PRB lien associated with one or more property-related benefits. That is, in addition to other forms of financing, such as primary first, second, etc., loans and home equity lines of credit, the present invention provides a means for financing certain property-related expenditures, such as various kinds of insurance. Although the embodiments disclosed above each include a PRB lien for various insurance products, a skilled artisan would understand that other purposes for the PRB lien are within the scope of the invention. For example, any underlying reason for which the PRB lien can be tied to the underlying property is contemplated. Also, it is contemplated that the PRB lien can remain in force or be obtained, for example, as a convenience to the homeowner, even if the home owner has paid off, or does not have, any other liens (e.g. first, second, etc., lien and/or HELOC lien) associated with the underlying property.

A skilled artisan would further understand that other aspects can be incorporated into the various exemplary embodiments discussed above without departing from the intended scope of the invention. For example, if the borrower fails to remit the amount due in any given month, or some other periodic timeframe, the shortfall amount, i.e., the amount equal to the difference between the amount due and the amount paid, can be applied, that is added, to any of the indicated balances due. For instance, the shortfall amount can be added to the principal amount owed for a first lien, if one exists, or it can be allocated to any one or more combination of a first lien amount, second lien amount, etc., a HELOC balance and any of the property-related benefit amounts.

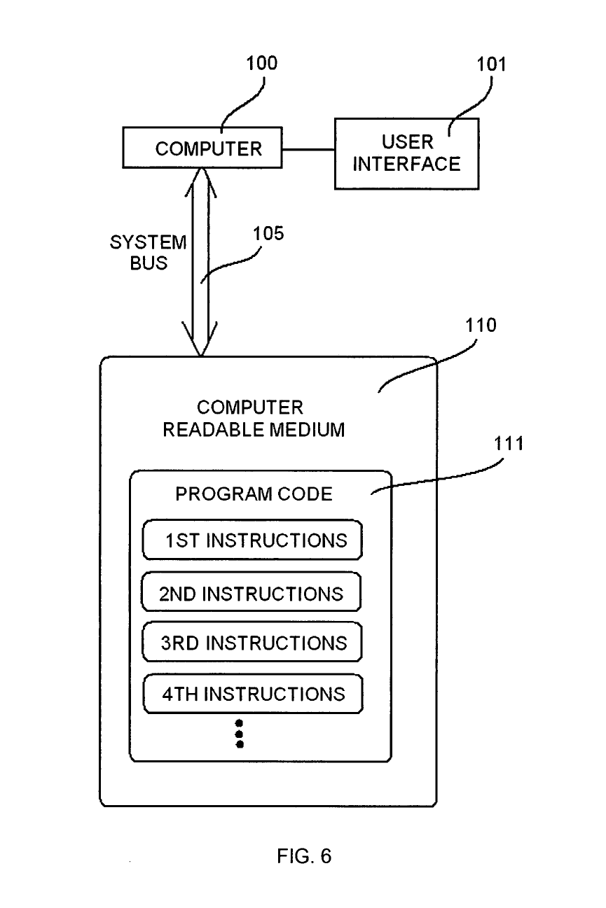

As shown in FIG. 6, in addition to the exemplary embodiments discussed above, the invention can also take the form of a computer program product accessible from a computer-usable or computer-readable medium 110 providing program code 111 for use by or in connection with a computer 100 or any instruction execution system. Further, computer 100 can optionally be operationally connected to a display device 101 or other known devices for readily obtaining and accessing data. For the purposes of this description, a computer-usable or computer readable medium 110 can be any apparatus that can contain, store, communicate, propagate, or transport the program for use by or in connection with the instruction execution system, apparatus, or device.

The computer-usable or computer readable medium 110 can be an electronic, magnetic, optical, electromagnetic, infrared, or semiconductor system (or apparatus or device) or a propagation medium. Examples of a computer-readable medium 110 include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus 105, which can comprise, for example, any known wired or wireless medium. The memory elements can include local memory employed during actual execution of the program code, bulk storage, and cache memories which provide temporary storage of at least some of the program code 111 in order to reduce the number of times code must be retrieved from bulk storage during execution.

A person of ordinary skill would understand that a method incorporating any combination of the details mentioned above would fall within the scope of the present invention as determined based upon the claims below and any equivalents thereof.

Other aspects, objects and advantages of the present invention can be obtained from a study of the drawings, the disclosure and the appended claims.

What is claimed is:

1. A method for financing at least one loan for a borrower, the method comprising:
preparing a property-related benefit (PRB) lien for obtaining at least one benefit associated with at least one specified item of property,
wherein the PRB lien includes at least one PRB interest rate determined by the particular respective benefit or benefits for which the PRB lien is prepared.

2. The method of claim 1, wherein said preparing the PRB lien does not provide for any amount of money to be placed under the control of the borrower.

3. The method of claim 1, further comprising:
preparing at least one additional lien associated with the at least one specified item of property.

4. The method of claim 3, further comprising:
canceling the PRB lien without affecting any attendant terms of the at least one additional lien.

5. The method of claim 1, wherein the benefit comprises insurance associated with the at least one item of property.

6. The method of claim 5, wherein the insurance comprises at least one insurance policy associated with the item of property and at least one respective second interest rate is associated with each insurance policy.

7. The method of claim 6, wherein the insurance comprises at least one of a private mortgage insurance policy, a homeowner's insurance policy and a home warranty/repair insurance policy.

8. The method of claim 1, further comprising preparing a statement associated with at least the PRB lien, the statement comprising at least one entry indicating an amount due by the borrower.

9. The method of claim 8, wherein the statement further comprises a plurality of entries, each entry indicating at least one respective amount due, wherein each of the respective amounts due is determined based on the at least one PRB interest rate.

10. The method of claim 9, further comprising allocating an amount of payment received from the borrower to the respective amounts due.

11. The method of claim 10, wherein if an amount of the payment received is less than the total amount of the respective amounts due, the allocation of the amount of payment received from the borrower comprises selectively allocating at least a portion of the amount of the payment received from the borrower to at least one of the respective amounts due.

12. The method of claim 11, further comprising preparing at least one additional lien associated with the at least one specified item of property, wherein the selectively allocating comprises prioritizing the allocation of the at least a portion of the amount of the payment received from the borrower between the PRB lien and the at least one additional lien.

13. The method of claim 12, wherein the prioritizing comprises assigning a highest priority to the amount due determined based on the at least one PRB interest rate.

14. The method of claim 10, wherein the allocation of the amount of payment received from the borrower comprises:
allocating the amount of payment received to at least a portion of the respective amounts due; and
if the amount of payment received is less than a total of the amounts due, increasing a principle balance of the PRB lien by a difference between the total of the amounts due and the amount of payment received from the borrower.

15. The method of claim 14, wherein the allocation of the amount of payment received comprises allocating at least a portion of the amount of payment received to one or more of a first lien, a second lien, a third lien, a HELOC and a PRB lien.

16. The method of claim 1, further comprising preparing at least one additional lien having at least one respective interest rate.

17. The method of claim 16, further comprising eliminating the PRB lien while at least one of the additional liens remains intact.

18. The method of claim 17, wherein the at least one additional lien comprises at least one of a primary mortgage lien and a home equity line of credit (HELOC).

19. A method of providing funding to a borrower, the method comprising:
preparing a primary lien comprising a primary amount and a primary interest rate, wherein the primary amount is to be paid back by the borrower over a specified period of time at the primary interest rate;
preparing a property-related benefit (PRB) lien comprising at least one PRB interest rate to be applied to a specified value associated with at least one of the primary lien and a specified item of property; and
permitting the PRB lien to be canceled during a lifetime of the primary lien without affecting the terms of the primary lien.

20. The method of claim 19, wherein the value to which the PRB interest rate is applied comprises one of a past value of the property and a current value of the property.

21. The method of claim 19, further comprising providing a statement to the borrower, wherein the statement identifies respective amounts owed regarding the primary lien and the PRB lien.

22. The method of claim 19, wherein the primary amount is used for purchasing specified real property and an amount determined by multiplying the at least one PRB interest rate and the specified value is for providing at least one insurance policy associated with the specified real property.

23. A financing method, the method comprising:
preparing a property-related benefit (PRB) lien, wherein the PRB lien is for obtaining a benefit associated with a specified item of property; and
assigning at least one PRB interest rate to the PRB lien, wherein the at least one PRB interest rate is or are determined by the particular benefit or benefits for which the PRB lien is prepared.

24. The method of claim 23, further comprising preparing a primary lien including a primary amount of money and having a corresponding primary interest rate.

25. The method of claim 24, further comprising eliminating the PRB lien while the primary lien remains intact.

26. The method of claim 24, further comprising preparing a subordinate lien comprising a respective amount of money to be transferred to the borrower and a respective interest rate.

27. The method of claim 26, further comprising eliminating the PRB lien while at least one of the primary lien and subordinate lien remains intact.

28. The method of claim 23, wherein the benefit comprises insurance associated with the specified item of property.

29. The method of claim 24, wherein the primary lien comprises a home equity line of credit (HELOC).

30. The method of claim 26, wherein at least one of the primary and subordinate liens comprises a home equity line of credit (HELOC).

31. A financial product comprising a property-related benefit (PRB) lien for providing funding for a benefit associated with a specified item of property and including at least one PRB interest rate applied to a value related to the item of property.

32. The financial product of claim 31, further comprising a first lien having a first amount and a first interest rate, wherein the PRB lien comprises a plurality of PRB interest rates each associated with a respective value corresponding to at least one of said first lien and the specified item of property.

33. The financial product of claim 31, wherein the PRB lien does not provide for an amount of money to be transferred to the borrower.

34. The financial product of claim 32, wherein the PRB lien can be canceled without affecting terms of the first lien.

35. A financial product comprising a PRB lien comprising a PRB interest rate and for obtaining a particular benefit associated with an item of property for a customer, wherein the benefit is provided by a second party different than the customer and no funds are transferred to the customer and wherein further, the PRB interest rate is determined by the particular benefit.

36. The financial product of claim 35, further comprising a first lien for transferring a first amount of money to a borrower and having a corresponding first interest rate.

37. The financial product of claim 36, further comprising a provision whereby the PRB lien can be canceled without affecting any terms of the first lien.

38. A computer program product for providing a financial product to a borrower related to a specified item of property, the computer program product comprising:
a computer readable medium;
a first set of program instructions for preparing a property-related benefit (PRB) lien for obtaining a benefit associated with at least one specified item of property, wherein the PRB lien includes a PRB interest rate determined by the particular benefit for which the PRB lien is prepared.

39. The computer program product claimed in claim 38, further comprising a second set of program instructions for preparing at least one additional lien associated with the at least one specified item of property.

40. A computer program product for providing a financial product to a borrower for the purpose of obtaining at least one benefit related to real property, the computer program product comprising:
a computer readable medium;
a first set of program instructions for preparing a PRB lien for obtaining a benefit associated with the real property, wherein no money is transferred to the borrower; and
a second set of program instructions for assigning an interest rate to the PRB lien, wherein the interest rate is determined by the particular benefit obtained.

41. The computer program product claimed in claim 40, further comprising a third set of program instructions for preparing a first lien including a first amount of money to be transferred to either the borrower or a seller of the real property, and having a corresponding first interest rate.

42. The computer program product claimed in claim 41, further comprising a fourth set of program instructions for generating a provision for selectively eliminating the PRB lien while terms of the first lien remain intact.

43. A system comprising:
a user interface for receiving at least one parameter of a financial product;
a computer for executing, based on the parameters received via the user interface, instructions comprising:
a first set of program instructions for preparing a PRB lien for obtaining a benefit associated with real property, wherein no money is transferred to the borrower; and
a second set of program instructions for assigning an interest rate to the PRB lien, wherein the interest rate is determined by the particular benefit obtained; and
an output for displaying results of the execution of the instructions.

44. The system as claimed in claim 43, wherein the computer selectively executes a third set of program instructions for preparing a first lien including a first amount of money to be transferred to either the borrower or a seller of the real property, and having a corresponding first interest rate.
